(19) United States
(12) Patent Application Publication
(10) Pub. No.: US 2006/0291519 A1
(43) Pub. Date: Dec. 28, 2006

(54) Increasing the resistance of crystals to optical damage

(76) Inventors: Karsten Buse, Bonn (DE); Joerg Hukriede, Lengerich (DE); Manfred Mueller, Bonn (DE)

Correspondence Address: KENYON & KENYON LLP, ONE BROADWAY, NEW YORK, NY, 10004, US

(21) Appl. No.: 10/541,480

(22) PCT Filed: Dec. 19, 2003
(86) PCT No.: PCT/DE03/04191

§ 371 Date: Sep. 5, 2006

(30) Foreign Application Priority Data
Jan. 4, 2003 (DE) 10300080.1

(51) Int. Cl. H01S 3/14

(52) U.S. Cl. 372/68

(57) ABSTRACT

The invention relates to a method for desensitizing a crystal exhibiting non-linear optical properties, in particular a lithium niobate or lithium tantalate crystal against damage of exposure to light action (optical damages). The similar type damages are caused by refraction index modifications induced by light. The dark conductivity of the crystal is increased by doping with extrinsic ions.

The present invention is directed to a method for desensitizing a crystal having nonlinear optical properties, in particular a lithium niobate or a lithium tantalate crystal, to the damaging effects of intense exposure to light (“optical damage”), the damage being caused by light-induced variations in the refractive indices.

Lithium niobate and lithium tantalate are oxidic crystals which have numerous applications in nonlinear optics. Thus, they are used in integrated optics, for example, as substrates for waveguide manufacturing. Utilizing the electrooptical effect, the refractive indices of the crystal are able to be changed by applying a voltage, making lithium niobate a frequently used material in the construction of fast modulators for use in telecommunications. In the fields of frequency doubling and frequency conversion of laser light, lithium niobate is an important material due to its large nonlinear coefficients. In particular, the feasibility of periodically poling the material (PPLN—“periodically poled lithium niobate”) has led to many important applications. Thus, PPLN is used, for example, to construct tunable light sources, so-called optical parametric oscillators (“OPO's”). In all of the applications mentioned here exemplarily, the problem of optical damage can arise.

For OPO's, volume crystals are used, which are 20 mm long, for example, and have a cross section of 1×5 mm². Since higher intensities typically enhance the efficiency of the processes involved, it is desirable to operate the components at the highest possible light intensities. Therefore, to optimally utilize the nonlinear properties of the crystal, intense laser light is focused by lenses into the material, or the light is guided in the crystal in waveguides. In this context, the following problem arises, however: The crystals react to the high intensities by changing their material properties. This effect is described as “optical damage.” It leads to a substantial spreading and scattering of the laser beams that are conducted through the material, thereby altering their intensity profile. As a result, the optical power conducted through the waveguide decreases considerably. In addition, lens effects, which can focus or defocus the beams, occur in the volume crystals, so that the carefully designed optical component is no longer able to fulfill its function. In this context, two effects, which may occur independently of one another, contribute to the optical damage in the lithium niobate and lithium tantalate.

The first to be mentioned here is the so-called “photorefractive effect”, which causes the charges to be redistributed among impurity sites in the material when the crystal is irradiated with light in the visible spectral region. The charge carriers are excited in the illuminated regions, move through the crystal, and are ultimately trapped at impurity sites in the unilluminated regions. In this context, the volume photovoltaic effect is the dominant charge-driving force in lithium niobate and lithium tantalate crystals. The charge distribution causes electrical space-charge fields to be built up in the material which modulate the refractive index due to the electrooptical effect. These light-induced refractive index inhomogenieties cause optical damage.

Different types of impurity sites contribute to the light-induced charge transfer, especially in the case of lithium niobate and lithium tantalate. Thus, the distinction is made between intrinsic impurity sites, i.e., those inherent to the material, and extrinsic impurity sites, i.e., those foreign to the material. The most important extrinsic impurity site is iron which occurs in lithium niobate and lithium tantalate as Fe²⁺ and Fe³⁺. In this context, Fe²⁺ acts as a donor and Fe³⁺ as a trap for electrons which can be redistributed in the material in response to incident light radiation. Even a small quantity of iron impurity is enough to build up strong light-induced space-charge fields and thus to produce interfering optical damage. Therefore, the not readily controllable residual iron impurity in the crystal poses a fundamental problem. It may be that optimized manufacturing processes have, in the meantime, been able to successfully produce commercial lithium niobate crystals having relatively small amounts of iron impurities, in which the iron concentration is only a few ppm (parts per million), but it has, nevertheless, not been possible to completely eliminate the optical damage. Besides iron, other transition metals form extrinsic impurity sites in lithium niobate and lithium tantalate that intensify the optical damage. Examples of these are copper, manganese, chromium or cerium.

The most important intrinsic impurity sites in lithium niobate that promote the charge transfer are formed by misplaced niobium ions in the crystal lattice which are inserted into a lithium site. Already for reasons of thermodynamics, a certain concentration of these impurity sites is always found in congruently melting lithium niobate. Incident light radiation can cause electrons to be released from these impurity sites and redistributed in the material, thereby producing optical damage due to the space-charge fields.

From the standpoint of energy, the iron impurity sites and the misplaced niobium ions are located in the band gap of the crystal. In relation to the conduction band, iron has a deeper location, in terms of energy, while misplaced niobium has a shallower location. This pattern is also described as a “two-center model”. In response to intense light irradiation, electrons can be excited from the impurity sites into the conduction band, where, after drifting freely, they are trapped by other impurity sites. On the other hand, charge carriers can also move through direct transitions from one impurity site into another, without having to travel a circuitous path via the conduction band.

The thermo-optical effect is another effect that contributes to optical damage. This refers to the change in the refractive indices of the material as a function of temperature. When a strongly focused laser beam strikes the crystal, intensities in the range of several gigawatts per square meter are reached. If a portion of the light is absorbed by the material, then the light energy is converted into thermal energy, and the crystal heats up locally. This likewise leads to local changes in the refractive index and thus to optical damage.

Under the related art, various methods are known for reducing the optical damage in lithium niobate or lithium tantalate. These methods can be divided into six subgroups, which are briefly outlined in the following:

The optical damage produced by incident light radiation in commercial lithium niobate crystals can be diminished by heating the crystals to temperatures of typically up to 200° C. This method is widespread and is used, in particular, for frequency doubling applications and in OPO's. It is also used for thermally tuning the phase-matching wavelength of the radiation. In this context, the altered refractive indices of the material at the operating temperature must be taken into account when designing the components. However, this does not pose a problem, since the temperature is increased homogeneously over the entire crystal when it is externally heated in a homogenous manner using an appropriate heater. The reason for the effect is interpreted as follows: The electronic photoconductivity is greatly increased by heating the material. In this manner, the light-induced space-charge fields are virtually short-circuited, with the result that the optical damage is dramatically reduced.

It is also known to dope the crystal with magnesium, zinc or indium in order to reduce the optical damage. The aim of this method is to prevent optical damage by eliminating the second, shallow center, in that large quantities of magnesium, zinc or indium are added to the crystal melt. It is problematic, however, that reducing the optical damage to an acceptable degree requires such a high concentration of the impurities in the crystal (in the case of Mg, approximately 5 mole %), that the optical quality of the crystals is seriously degraded. In particular, the homogeneity of the crystal suffers, so that the material is not suited for applications which require relatively large crystals. However, it is precisely these applications that are of particular interest, since large crystals greatly enhance the efficiency of nonlinear processes. Here as well, the magnesium doping makes the crystals less suited for periodic poling. Lithium niobate and lithium tantalate doped in this manner have virtually no commercial uses, since they are not competitive in terms of price with commercial, undoped crystals.

Another method that presents itself pertains to the geometry along the c-axis. The method utilizes the fact that the space-charge fields causing the optical damage build up first and foremost along the crystallographic c-axis in the material. For that reason, when working with integrated optical components, it is expedient to allow the optical waveguides to run along the c-axis in order to minimize the optical damage in this way. Thus, the disturbing space-charge fields build up along the waveguide and not perpendicularly thereto over its cross section.

In addition, it is known to use periodically poled lithium niobate (PPLN). The PPLN is distinguished in that the direction of the crystallographic c-axis is periodically spatially inverted. This has the effect of dividing the crystal into many small domains typically having a width of only a few micrometers. Since adjoining regions of positive and negative net charge cancel each other out, the light-induced charge distribution integrated over a large crystal region becomes highly inefficient. This, in turn, leads to a substantial reduction in the optical damage since the resulting space-charge fields are comparatively small. Nevertheless, even this negligible effect can violate the phase-matching conditions and thus lead to component failure.

To minimize the damage, stoichiometric lithium niobate can also be used. This is understood to be a crystal composition which, based on the total number of lithium ions and niobium ions, has an approximately 50% lithium ion content. On the other hand, commercial, so-called “congruently melting” material only has a 48.4% lithium content. Stoichiometric lithium niobate is distinguished by a steep rise in photoconductivity. As a result, the light-induced space-charge fields are short-circuited, and the optical damage is reduced. As in the case of the magnesium-doped material, the problem also arises when working with stoichiometric crystals, that the material can not be reproducibly manufactured. This makes such crystals unsuited for commercial use. Another possibility provides for using integrated optical waveguides, in which chemical proton exchange (APE-“annealed proton exchange”) processes are used to increase the refractive index, as is required for light guidance. These waveguides exhibit greatly diminished optical damage in contrast to waveguides manufactured using conventional titanium indiffusion. This effect is interpreted as follows: The property of altering the degree of reduction [Fe²⁺]/[Fe³⁺] of the existing residual iron impurity is ascribed to the protons present in the material. The presence of many protons in the material is supposed to result in a change in the charge state from Fe²⁺ to Fe³⁺. The susceptibility of the material to optical damage is thereby considerably reduced. Titanium-indiffused waveguides in lithium niobate exhibit precisely the reverse effect. It is speculated in this case that the indiffused titanium leads to Fe³⁺ being converted into Fe²⁺. In actuality, the titanium-indiffused waveguides are much more sensitive to optical damage.

The object of the present invention is to devise a method that is able to be implemented cost-effectively, using simple means, and which will enable crystals having nonlinear optical properties, in particular lithium niobate or lithium tantalate, to be efficiently desensitized to optical damage.

This objective is achieved by a method as set forth in claim 1.

The general idea at the core of the present invention is to minimize the susceptibility of the crystals to optical damage in that the dark conductivity of the material is enhanced by carrying out suitable treatments. This results in a short-circuiting of the space-charge fields that cause the optical damage, so that the effect becomes less pronounced. In this context, the dark conductivity may be selectively increased in accordance with the present invention in different ways:

On the one hand, the proton concentration of the material may be increased. Thus, it is known that the dark conductivity of undoped and weakly iron-doped lithium niobate crystals is dominated by mobile protons. In this context, the protonic conductivity increases exponentially with temperature. An activation energy of 1.1 eV for the process has been ascertained from temperature-dependent measurements. The high dark conductivity of the protons is utilized in the thermal fixing method, for example, to produce quasi-permanent holograms in lithium niobate. In the process, the material is heated during or following luminous exposure to temperatures of around 180° C., which greatly increases the mobility of the protons in the material. The protons then drift in the space-charge field produced by incident light radiation, and compensate for it because of their charge. As a result, during the fixing process, no or only slight diffraction efficiencies of written holograms are able to be detected.

The proton concentration in material known till now is established by the crystal growing process and is thus preset by the manufacturer. Measurements show that, at its maximum, the proton concentration is about 2.5×10²⁴ m⁻³ (see table). Measured proton concentrations of congruently melting, undoped lithium niobate crystals are entered in the table. It turns out that the proton concentrations of commercial crystals from various manufacturers do not deviate very much from one another. Therefore, from this, one may infer that commercial, congruently melting lithium niobate crystals have a maximum proton concentration of 2.5×10²⁴ m^{31 3}.

| Manufacturer | Designation | Analysis | c_{H}^{₊}[10²⁴ m⁻³] |
|---|---|---|---|
| Crystal Technology | CR1 | congruent | 1.89-2.19 |
| Deltronic Crystal | DEL1 | congruent | 0.91-1.41 |
| Oxide | OX1 | congruent | 1.59-1.78 |
| Oxide | OX2 | congruent | 1.40-1.44 |
| Oxide | OX3 | congruent, 1% MgO | 0.50-0.56 |
| Oxide | OX4 | congruent, 1% MgO | 0.30-0.32 |
| Roditi | RO1 | congruent | 1.65-1.84 |
| Thorlabs | TH1 | congruent | 2.03-2.42 |

In addition, it is known that the proton concentration is altered by one of the described methods. The present invention aims to take advantage of the direct relation between the proton concentration and the reduction in optical damage. It proves to be especially advantageous in this context to also subject the crystal to a heating process. This procedure is not known from the related art. Finally, known methods heretofore did not ascribe any importance to lithium niobate or lithium tantalate volume crystals as far as reducing the optical damage is concerned. Until now, no relation was seen between the protonic dark conductivity and the reduction in the optical damage.

From the related art, it is known that proton-exchanged waveguides in lithium niobate, thus integrated optical components, exhibit a greatly enhanced dark conductivity. However, it is not known to specifically apply this effect to standard crystals or to use it to reduce optical damage. In known methods heretofore, it is also not known to heat these components for purposes of further increasing the protonic dark conductivity.

It has also already been reported very generally that regions in lithium niobate crystals having a high proton concentration exhibit a higher resistance to optical damage. However, it has not been proposed to utilize the increased proton concentration to enhance the dark conductivity and to thereby take advantage of the effect. This was also not possible since, within the scope of this work, no interpretation whatsoever of the effect had been provided, and no relation between the proton concentration and the dark conductivity had been established. Also, it was not proposed to heat the crystal in order to enhance the dark conductivity.

In accordance with the present invention, the protonic conductivity is enhanced by selectively increasing the proton concentration in the material by carrying out a suitable pretreatment. Dark conductivity σₒ may be expressed as

$$σ = {σ}_{0} exp ( - \frac{ɛ}{{k}_{B} T} ) , \\ {σ}_{0} = \frac{{c}_{{H}^{+}} {ⅇ}^{2} {D}_{0}}{{k}_{B} T}$$

It increases accordingly, on the one hand, with temperature T and, on the other hand, linearly with proton concentration C_{H+}. In this context, e is the elementary charge, k_{B} the Boltsmann constant, Dₒ the exponential prefactor of the diffusion constant, and ε=1.1 eV the already introduced activation energy.

The proton concentration of lithium niobate crystals is determined by analysis of absorption measurements. To that end, the OH⁻ stretch vibration was detected at 2870 nm using ordinary polarized light. The height of this absorption band is proportional to the proton concentration of the material and is described as:
C_{H}_{⁺}=1. 67×10²² m⁻²×α₂₈₇₀ₙₘ

In this context, α₂₈₇₀ₙₘ is the absorption coefficient at the indicated wavelength.

In accordance with the present invention, the proton concentration is increased by a significant measure, an increase of over 50% being considered a significant increase. As a result, the dark conductivity of the material likewise increases. Consequently, the strength of the light-induced space-charge field is reduced, while the resistance of the material to optical damage is enhanced.

The proton concentration of commercial lithium niobate crystals may be permanently increased by tempering processes or by chemical processes. Methods that lend themselves to this include heating the crystals in a proton-rich atmosphere at high temperatures of around 1000° C. and/or with the application of an electrical field and/or under a high pressure. In a chemical proton-exchange process, lithium ions are replaced by protons. These processes enable the proton concentration to be increased to levels significantly higher than those of commercial crystals, which, at a maximum, are about 2.5×10²⁴m⁻³. The described methods make it possible to achieve a proton concentration of greater than 4×10²⁴m⁻³.

In one particular embodiment, the dark conductivity is enhanced beyond the commercial level by significantly increasing the deuteron concentration. It is considered significant in this case for a value of 1×10²⁴ m⁻³ to be exceeded. In this embodiment, instead of the protonic dark conductivity, a deuteronic dark conductivity comes into effect.

Both mentioned types of doping may be implemented by heating the crystal in a suitably ion-enriched atmosphere and/or subjecting it to an elevated pressure and/or to an electrical field.

In the process, the dark conductivity may be increased, so to speak, by increasing the iron concentration of the material. Thus, highly iron-doped lithium niobate crystals exhibit a dark conductivity which is no longer dominated by protons. Instead, at this point, the dark conduction is of an electronic nature: In response to thermal excitation, electrons may be released from Fe²⁺ centers and trapped by Fe³⁺ centers. In this way, a light-induced space-charge field is quickly erased again. The present invention is based on doping the material so heavily with iron that the electronic dark conductivity is significantly increased. This, in turn, has as a consequence a short-circuiting of the light-induced space-charge fields, which increases the resistance to optical damage.

In heavily iron-doped lithium niobate crystals, a significant absorption band forms in the visible spectral region, whose maximum is at a wavelength of 477 nm. This absorption, which behaves proportionally to the Fe²⁺ concentration in the crystal, is disadvantageous when the optical component is to be operated using visible light. However, by heating the crystal for a short period of time in a suitable atmosphere at temperatures of around 1000° C., Fe²⁺ is able to be permanently converted to Fe³⁺, and the disturbing absorption thereby reduced.

At the present time, heavily iron-doped lithium niobate or lithium tantalate crystals are not used for reducing optical damage. Instead, exactly the opposite is occurring: The manufacturers attach great importance to growing the purest possible crystals which contain as few iron impurities as possible. It is intended in the process to eliminate the photorefractive effect and thereby prevent the optical damage from occurring.

Moreover, an enhanced dark conductivity may be accomplished by not doping the material with iron, but rather with other extrinsic ions, whose total concentration substantially surpasses the value of residual impurities of commercial, undoped lithium niobate crystals. It is considered significant in this case for a value of 2×10²⁴ m⁻³ to be exceeded.

It is advantageous with regard to both methods proposed by the present invention to link the particular effect to the method of increasing the temperature of the crystal. In this manner, the protonic, the deutronic, and, respectively, the electronic dark conductivity are enhanced still further, so that the crystal's resistance to optical damage is further increased. While retaining the crystal heating method, this permits the use of optical components which are capable of far greater optical performance than in known methods heretofore, before interfering optical damage occurs.

In summary, it can be said that the present invention represents a new method for reducing optical damage in volume crystals and thus for making the material suitable for a larger range of application. The dark conductivity of the material is greatly enhanced by doping the crystals with large quantities of protons, deuterons or iron ions. The effect is intensified by additionally heating the material. The method leads to short-circuiting of the light-induced space-charge fields and thus to a reduction in the photorefractive effect. Consequently, the crystal becomes resistant to optical damage.

1-10. (canceled)

11. A method for desensitizing a crystal, comprising:
providing the crystal having nonlinear optical properties; and
doping with extrinsic ions the crystal, wherein the doping of the crystal enhances the dark conductivity of the crystal, and the crystal is desensitized to damaging effects of intense exposure to light which cause light-induced variations in the refractive indices of the crystal.

12. The method as recited in claim 11, wherein the crystal is doped with protons which increase the protonic dark conductivity, a concentration of more than 3×10²⁴ m⁻³, in particular of more than 4×10²⁴ m⁻³ being achieved.

13. The method as recited in claim 11, wherein the crystal is doped with deuterons which increase the deuteronic dark conductivity, a concentration of more than 1×10²⁴ m⁻³ being achieved.

14. The method as recited in claim 11, wherein the crystal is doped with ions which increase the electronic dark conductivity, a concentration of more than 2×10²⁴ m⁻³ being achieved.

15. The method as recited in claim 14, wherein the ions are iron ions, whose concentration reaches more than 1×10²⁵ m⁻³.

16. The method as recited in claim 11, wherein the ion concentration is increased by heating the crystal in an ion-rich atmosphere.

17. The method as recited in claim 16, wherein the heating process is carried out under high pressure, in particular of over 100 bar.

18. The method as recited in claim 11 further comprising applying an electrical field to the crystal during the doping process.

19. A crystal having nonlinear optical properties comprising:
an increased dark conductivity,
wherein the increased dark conductivity is effected by doping the crystal with extrinsic ions, the doping of the crystal enhancing the dark conductivity of the crystal, and the crystal being desensitized to damaging effects of intense exposure to light which cause light-induced variations in the refractive indices of the crystal.

20. An optical component comprising:
a crystal having nonlinear optical properties,
wherein the crystal has an increased dark conductivity, and
wherein the increased dark conductivity is effected by a doping of the crystal with extrinsic ions, the doping of the crystal enhancing the dark conductivity of the crystal, and the crystal being desensitized to damaging effects of intense exposure to light which cause light-induced variations in the refractive indices of the crystal.

21. The method of claim 11 wherein the crystal is a lithium niobate crystal.

22. The method of claim 11 wherein the crystal is a lithium tantalate crystal.

23. The method of claim 11 wherein the crystal is doped with protons which increase the protonic dark conductivity, achieving a concentration of more than 4×10²⁴ m⁻³.
